(19) United States
(12) Patent Application Publication
(10) Pub. No.: US 2018/0021787 A1
(43) Pub. Date: Jan. 25, 2018

(54) LUBRICANT PACK FOR A PAPER SHREDDER

(71) Applicant: Hsiang Hsi WANG, Taipei City (TW)

(72) Inventor: Hsiang Hsi WANG, Taipei City (TW)

(21) Appl. No.: 15/216,729

(22) Filed: Jul. 22, 2016

(51) Int. Cl. B02C 18/16; B65D 75/30; B02C 18/00; F16N 19/00

(52) U.S. Cl. CPC B02C 18/16; F16N 19/00; B65D 75/30; B02C 18/0007; B02C 2018/166

(57) ABSTRACT

A lubricant pack for a paper shredder is presented, which includes two covering layers disposed side-by-side and edges thereof are thermally welded to form a sealed bag. Lubricant is enclosed in the bag, and at least one inner seal is configured in the bag. Surrounded by the inner seal is a hollow region not containing the lubricant. When the paper shredder cuts the lubricant pack, air contained in the lubricant tends to be released from the hollow region. Another lubricant pack for a paper shredder is presented, which includes two covering layers disposed side-by-side and edges thereof are thermally welded to form a sealed bag. Lubricant is enclosed in the bag, and at least one an inner seal is configured in the bag. Surrounded by the inner seal is a solid region not containing the lubricant, and multiple hollow impressions are formed in the solid region. When the paper shredder cuts the lubricant pack, air contained in the lubricant tends to be released from the hollow impressions of the solid region.

### FIELD OF THE INVENTION

The present invention is related to a paper shredder, and more particularly to a lubricant pack for a paper shredder, wherein the lubricant can be contacted with cutting blades for the purpose of lubrication during the breaking of the lubricant pack in the paper shredder.

### BACKGROUND OF THE INVENTION

As we know, when a paper shredder works, multiple cutting blades inserted through two parallel rotary shafts cut passing papers into pieces or chips by rotation of the rotary shafts powered by a motor and a gear box. During cutting, friction of the metallic cutting blades results in high temperature. After long-term use, the efficiency of the cutting blades reduces, and the noise generated by the cutting blades increases, so that entire operating life of the paper shredder lowers. Indeed, there is a need to maintain and lubricate the cutting blades of the paper shredder.

In the first generation lubricant pack, a lubricant-soaked paper is sandwiched in between two oil-proof covering layers, or the lubricant is directly packed in the two covering layers without the paper. However, when the lubricant pack passes through cutting blades of a paper shredder, air contained in the lubricant squirts out of the pack because of compression. This may shock the user standing nearby, and lead to lubricant pollution of surroundings.

In order to solve the above squirting problem, the second generation lubricant pack is presented in U.S. Pat. No. 7,793,876. The lubricant pack is sealed at its edges with an inner seal and an outer seal, and vents are mounted between the two seals.

The third generation lubricant pack is presented in U.S. Pat. No. 9,239,132. This lubricant pack not only has two seals and vents as used in the second generation one, but also is sealed at the center thereof with a cruciform seal to separate the original big packet into several small packets.

The fourth generation lubricant pack is presented in U.S. patent application Ser. No. 14/471,662. The lubricant pack is sealed at its edges, and an interior seal of the lubricant pack is separated into at least one interior region. Any peripheral region and the interior region are not linked with each other to form independent regions, and the independent regions are filled with the lubricant. This can prevent pooling of the lubricant resulted from precipitation.

The foregoing lubricant packs have distinct structural features, but their objectives are the same, to provide the desirable lubrication effect on the cutting blades of the paper shredder and to prevent the squirting and pooling problems. However, all of them have complicated structural features and are made via complex fabrication procedures, so each has a high production cost. The inventor therefore makes efforts in creating a high performance lubricant pack for a paper shredder, and the lubricant pack has a simple structural feature and is made via convenient fabrication procedures.

### SUMMARY OF THE INVENTION

After long-term investigation, the inventor proposes that an easy way to overcome the squirting problem is to configure stress concentrators at an appropriate location of a lubricant pack. According to continuum mechanics, a stress means force endured on unit area. In other words, the smaller the unit area is, the greater the stress is. Thereby, the stress concentrators are ready to be breakdown points. Such theory is applied in a lubricant pack for a paper shredder so that multiple stress concentrators are designed at an appropriate location of the lubricant pack. When the designed stress concentrators of the lubricant pack pass through cutting blades of the paper shredder, compressed air contained in the lubricant is released from these open regions to give the desirable lubrication effect on the cutting blades without lubricant squirting.

Therefore, an objective of the present invention is to provide a lubricant pack for a paper shredder, and multiple stress concentrators are configured at an appropriate location thereof. When the lubricant pack passes through the cutting blades of the paper shredder, the stress concentrators continuously pass through the cutting blades. In such a manner, compressed air contained in the lubricant is released from these stress concentrators, which cannot result in the lubricant squirting during the lubrication for the cutting blades.

For achieving the above objective, a lubricant pack for a paper shredder is presented in the present invention, which includes two covering layers disposed side-by-side and edges thereof are thermally welded to form a sealed bag. Lubricant is enclosed in the bag, and at least one inner seal is configured in the bag. Surrounded by the inner seal is a hollow region not containing the lubricant. By such structure, when the paper shredder cuts the lubricant pack, air contained in the lubricant tends to be released from the hollow region. Another lubricant pack for a paper shredder is presented in the present invention, which includes two covering layers disposed side-by-side and edges thereof are thermally welded to form a sealed bag. Lubricant is enclosed in the bag, and at least one an inner seal is configured in the bag. Surrounded by the inner seal is a solid region not containing the lubricant, and multiple hollow impressions are formed in the solid region. By such structure, when the paper shredder cuts the lubricant pack, air contained in the lubricant tends to be released from the hollow impressions of the solid region.

### BRIEF DESCRIPTION OF THE DRAWINGS

FIG. 1 is a structural diagram illustrating a first embodiment of the present invention;

FIG. 2 is a structural diagram illustrating a second embodiment of the present invention;

FIG. 3 is a structural diagram illustrating a third embodiment of the present invention;

FIG. 4 is a structural diagram illustrating a fourth embodiment of the present invention;

FIG. 5 is a structural diagram illustrating a fifth embodiment of the present invention; and

FIG. 6 is a structural diagram illustrating a sixth embodiment of the present invention.

### DETAILED DESCRIPTION OF THE INVENTION

Further characteristics of the present invention are discussed below by reference to the embodiments in conjunction with the accompanying drawings.

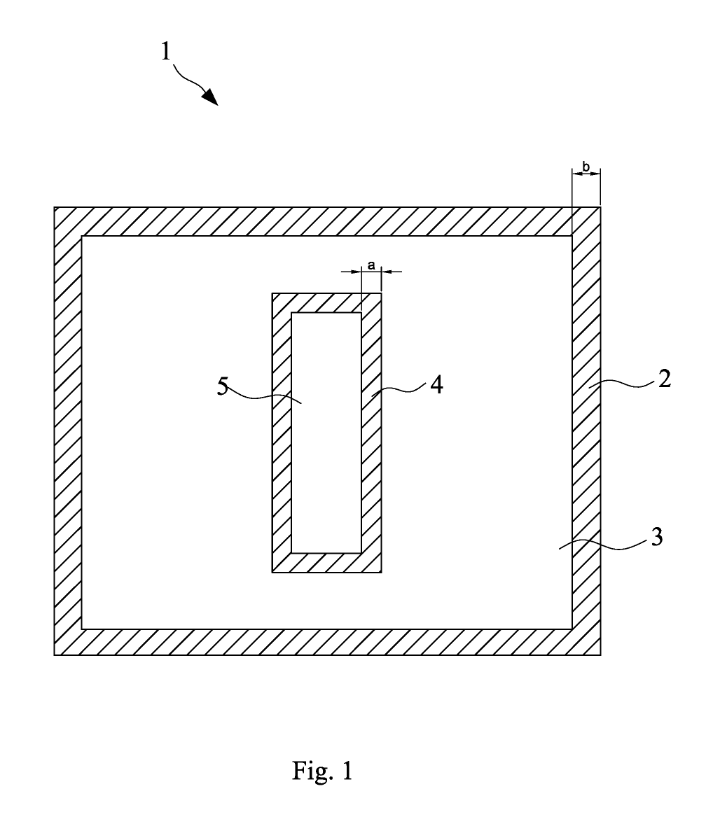

As shown in FIG. 1, a lubricant pack (1) according to a first embodiment of the present invention is depicted, which includes two covering layers disposed side-by-side and edges (2) thereof are thermally welded to form a sealed bag (3). Lubricant (not shown) is enclosed within the bag (3). The characteristic of the present embodiment is that at least one inner seal (4) is configured in the bag (3), and surrounded by the inner seal (4) is a hollow region (5) not containing the lubricant. Preferably, a width (a) for sealing the hollow region is smaller than that (b) for sealing the bag. As such, when a paper shredder cuts the lubricant pack, the smaller width forms stress concentrates to release air contained in the lubricant from the hollow region (5).

In this embodiment, the hollow region (5) may be in a lengthwise rectangle, but may be in another geometrical shape, e.g. a circular shape, a star shape, or a polygonal shape.

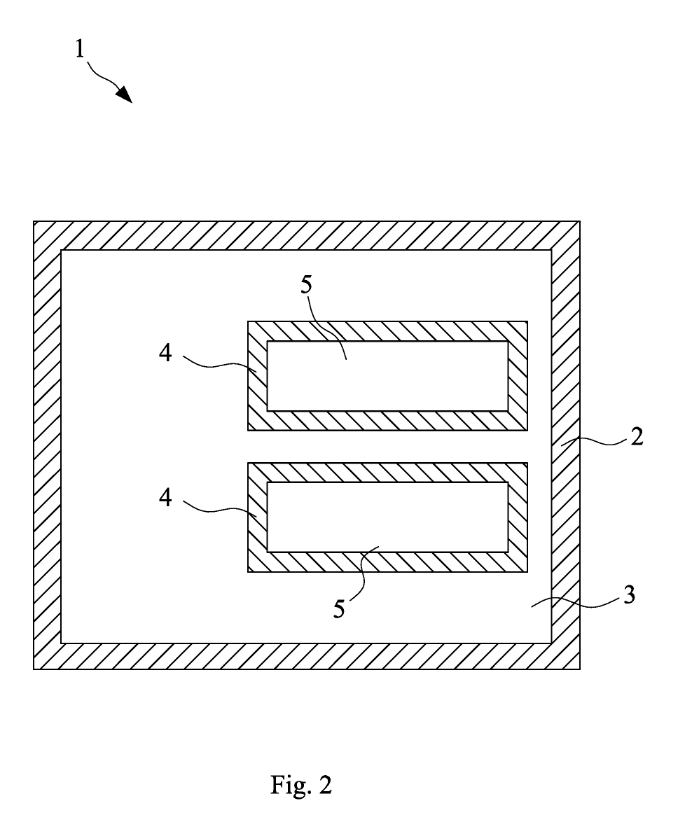

As shown in FIG. 2, multiple hollow regions (5) according to a second embodiment are arranged in parallel laterally.

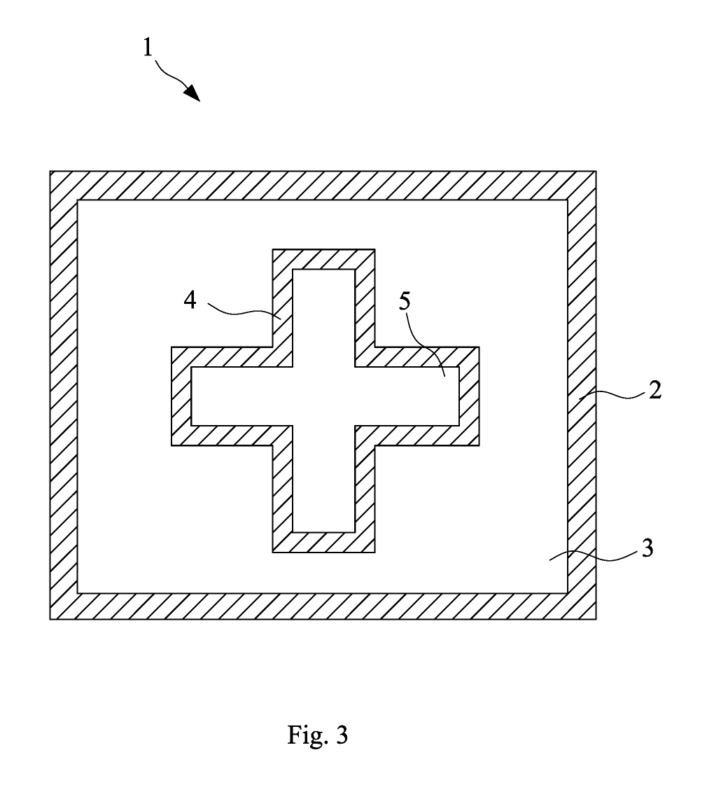

As shown in FIG. 3, a hollow region (5) according to a third embodiment is in a cruciform formed with a lengthwise hollow region and a widthwise hollow region.

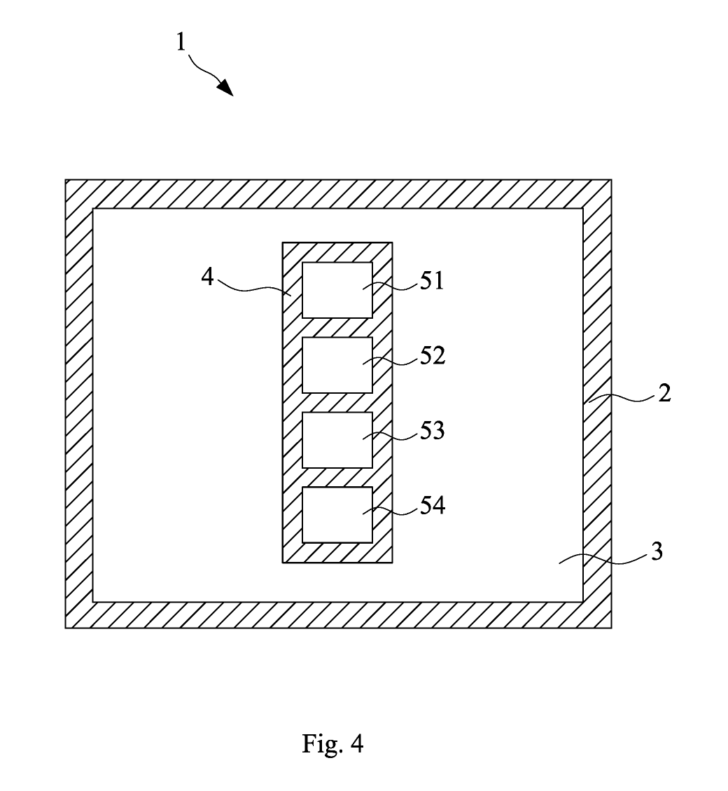

As shown in FIG. 4, a hollow region in a lengthwise rectangle is further sealed to separate to multiple small hollow regions (51, 52, 53, and 54).

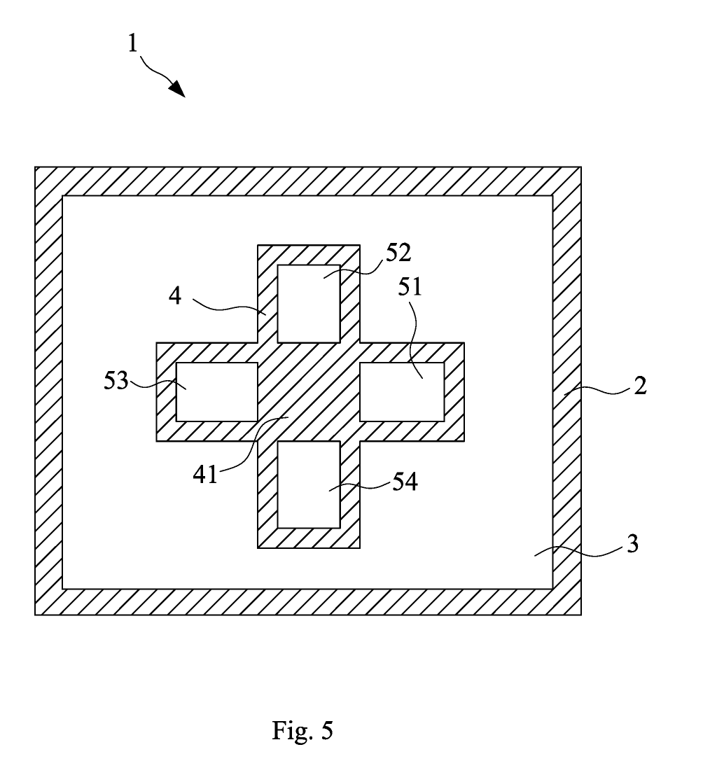

As shown in FIG. 5, since the cruciform of the hollow region (5) in the third embodiment leads to softening the lubricant pack (1), a solid reinforcing seal (41) is configured at a position where the lengthwise hollow region is intersected with the widthwise hollow region to strengthen the lubricant pack. The hollow region is separated into multiple small hollow regions (51, 52, 53, and 54) around the solid reinforcing seal (41).

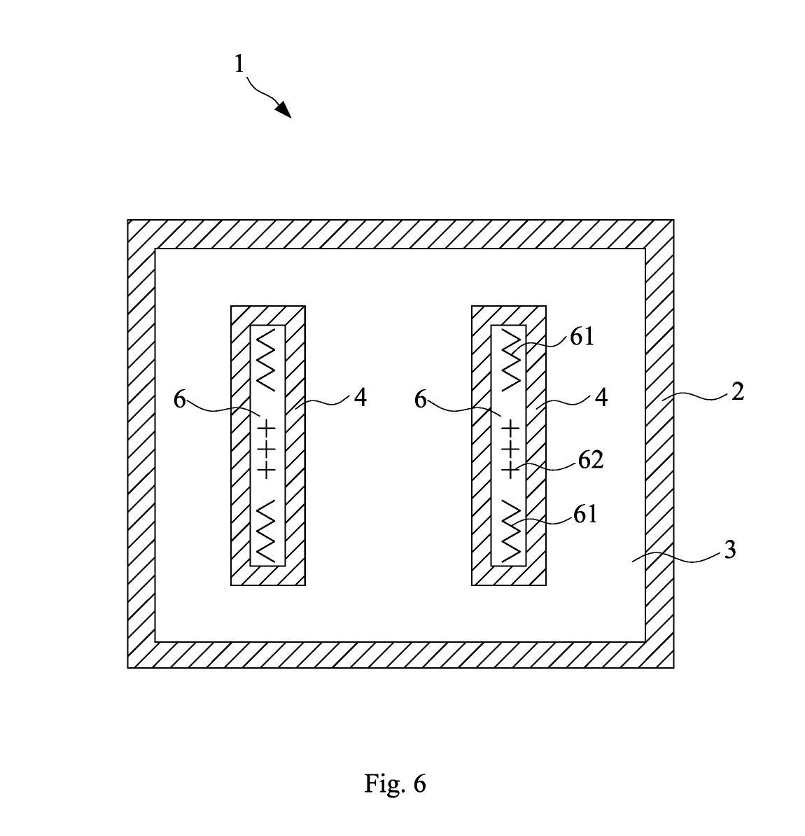

Every bag (3) of the foregoing embodiments is configured with at least one inner seal (4), and surrounded by the inner seal (4) is the hollow region (5). As such, when a paper shredder cuts the lubricant pack, stress concentrators are formed on the lubricant pack to release air contained in the lubricant from the hollow region (5). Although the fifth embodiment shown in FIG. 5 can strengthen the lubricant pack with the solid reinforcing seal (41), the hollow region (5) still leads to entirely softening the lubricant pack. As shown in FIG. 6, a lubricant pack (1) according to a sixth embodiment of the present invention is depicted, which includes two covering layers disposed side-by-side and edges (2) thereof are thermally welded to form a sealed bag (3). Lubricant (not shown) is enclosed within the bag (3). At least one inner seal (4) is configured in the bag (3), and surrounded by the inner seal (4) is a solid region (6) not containing the lubricant. In addition, multiple hollow impressions are formed in the solid region (6), and each hollow impression may be a triangular hollow impression (61) or a cruciform hollow impression (62) so that the entire hardness of the lubricant pack increases.

As above, the key feature of the present invention is that stress concentrators are configured in the lubricant pack. When the stress concentrators of the lubricant pack pass through the cutting blades of a paper shredder, compressed air contained in the lubricant is released from these stress concentrators. In such a way, lubricant squirting can't take place during the lubrication of the cutting blades. In summary, the present invention provides a lubricant pack having a simple structural feature and made via convenient fabrication procedures, brings a desirable lubrication effect on the cutting blades of a paper shredder, and avoids lubricant squirting. That is, those skilled in this art can acknowledge the present invention as unobvious over those prior lubricant packs. While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lubricant pack for a paper shredder comprising:
two covering layers disposed side-by-side;
wherein edges of the two covering layers are thermally welded to form a sealed bag;
the lubricant is enclosed in the bag;
at least one inner seal is configured in the bag; and
surrounded by the inner seal is a hollow region not containing the lubricant.

2. The lubricant pack as claimed in claim 1, wherein the hollow region is in a geometrical shape.

3. The lubricant pack as claimed in claim 1, wherein a width for sealing the hollow region is smaller than that for sealing the bag.

4. The lubricant pack as claimed in claim 1, wherein a width for sealing the hollow region is equal to that for sealing the bag.

5. The lubricant pack as claimed in claim 1, wherein the hollow region is sealed to separate to at least two small hollow regions.

6. A lubricant pack for a paper shredder comprising:
two covering layers disposed side-by-side;
wherein edges of the two covering layers are thermally welded to form a sealed bag;
the lubricant is enclosed in the bag;
at least one inner seal is configured in the bag;
surrounded by the inner seal is a solid region not containing the lubricant; and
hollow impressions are formed in the solid region.

7. The lubricant pack as claimed in claim 6, wherein each hollow impression is in a geometrical shape.
